(19) United States
(12) Patent Application Publication
(10) Pub. No.: US 2015/0100330 A1
(43) Pub. Date: Apr. 9, 2015

(54) METHOD AND SYSTEM OF IDENTIFYING INFECTIOUS AND HAZARDOUS SITES, DETECTING DISEASE OUTBREAKS, AND DIAGNOSING A MEDICAL CONDITION ASSOCIATED WITH AN INFECTIOUS DISEASE

(71) Applicant: Assaf Shpits, Zoran (IL)

(72) Inventor: Assaf Shpits, Zoran (IL)

(21) Appl. No.: 14/048,066

(22) Filed: Oct. 8, 2013

(51) Int. Cl. G06F 19/00

(52) U.S. Cl. CPC G06F 19/3493
USPC 705/2

(57) ABSTRACT

A method and system for detecting and identifying infectious sites by: receiving location data from a mobile device associated with a user, receiving health data for the user, determining an illness being suffered by a user, if the illness is an infectious disease, calculating an incubation period for the disease in the user, backtracking through the user's location data to determine a location where the user was during the incubation period, identifying each such location as an infectious site, notifying affected users who have been to the infectious site, and requesting real-time feedback from affected users in order to confirm, reject, or refine the identification of the infectious site

### FIELD AND BACKGROUND OF THE INVENTION

The present invention relates to a method and system for detecting and identifying disease outbreaks in real-time or near real-time, notifying affected users, and providing users with a variety of additional health information and valuable services via a user's mobile device.

Influenza, more commonly known as “flu”, spreads around the world in seasonal epidemics, resulting in about three to five million yearly cases of severe illness and about 250,000 to 500,000 yearly deaths, rising to millions in some pandemic years. Often, new influenza strains appear when an existing flu virus spreads to humans from another animal species, or when an existing human strain picks up new genes from a virus that usually infects birds or pigs. In April 2009, a novel flu strain evolved that combined genes from human, pig, and bird flu. Initially dubbed “swine flu” and also known as H1N1, it emerged in Mexico, the United States, and several other nations leading the World Health Organization (WHO) to officially declare the outbreak to be a pandemic on 11 Jun. 2009. According to WHO statistics, by July 2010 the virus had killed more than 18,000 people, although a study published in the June 26 issue of The Lancet estimated the death rate was as high as 284,500 to 575,000 people.

Five hundred years ago, the spread of disease was largely constrained by the main mode of transportation of the time: people traveling on foot. An outbreak in one town would slowly ripple outward with a pattern similar to water ripple. The Black Death moved across 14th century Europe in much this way.

Today, because of the ease and relative speed of transportation, disease migrates across populations and geography much faster. The 2003 SARS outbreak is a good example. SARS-like symptoms first appeared in China in November 2002. Between November 2002 and February 2003, hundreds of people in China were hospitalized with a mysterious respiratory illness. From that point on, the disease began to spread across the globe, however little was known about the spreading disease until March of that year when it was determined that a global outbreak was in effect with confirmed cases being reported in Hong Kong, Vietnam, Singapore, Ireland, Germany and Canada.

Subsequent investigation revealed how the disease spread across the globe. On Feb. 21, 2003, a man known as Patient A traveled from China, where he contracted the disease, to Hong Kong and infected 12 people staying in the same hotel. Investigators say these patients in turn spread the illness to others in Hong Kong, Vietnam, Singapore, Ireland, Germany and Canada. The next day Patient A was hospitalized in Hong Kong and the following day he died. Four hospital workers and two family members became ill with the same symptoms. On Mar. 5, 2003, a 78-year-old woman who had traveled to Hong Kong in February died of SARS in Toronto. By Mar. 17, 2003, Canadian health officials reported 11 cases of SARS in Toronto, British Columbia and Alberta. On Mar. 24, 2003, health officials in Singapore quarantined hundreds of people possibly exposed to SARS. Eleven days later, on Apr. 4, 2003, WHO officials reported a total of 2,353 probable SARS cases, 84 of them fatal, in 16 different countries. Had the outbreak been identified as such much earlier, there is a chance it could have been contained to China and Hong Kong, and spared dozens of lives across the globe.

Thus there is a need for a system that can detect, identify, and track outbreaks in real-time or near real-time in order to help contain the spread of disease. U.S. Pat. No. 7,705,723 describes a method whereby user locations are collected over time via a user's mobile device and correlated with locations in which a disease was identified. The system first receives a report of a user infected with a confirmed disease, after which the user's close contacts during the incubation period of the disease are alerted.

However the method suffers from several drawbacks. First, a user is only alerted to potential exposure after the fact, that is, once the user had already been likely exposed to the disease. Second, the system relies on receiving confirmation of an illness. At that point the close contacts during the incubation period are backtracked and alerted for possible exposure. Third, the close contacts need to be in close physical proximity in order to be alerted to possible exposure. Even then, the system does not determine the likelihood of the infection being transmitted. Fourth, the system does not take into account a user's personal information, such as age, which can affect the incubation period. Fifth, the method is only useful for tracking diseases that spread person to person. Diseases that aren't transmitted by a person (e.g. food poisoning) are not detected even though other users may catch it at the source. Sixth, the method does not detect unknown diseases. Finally, the system does not track or alert users to other location-based hazards.

### SUMMARY OF THE INVENTION

The present invention overcomes these difficulties with the prior art by providing an outbreak detection system which can detect an outbreak before a confirmed disease is reported, and alert users who may be exposed or are at risk of becoming exposed. In addition, real-time disease data is gathered from hundreds of users and analyzed for valuable information about the disease, its parameters of infection, and its source.

The present invention is a comprehensive real-time or near real-time outbreak management and safety alert system. The system uses “crowd wisdom”, or current information gathered from a large audience of participating users in order to detect possible disease outbreaks in real-time as they are occurring. As used herein “in real-time” means the information gathered from users is processed and analyzed within several minutes, and “disease” means infectious disease. Users input incident reports containing disease symptoms or a confirmed disease into a geolocation-enabled mobile device such as a mobile phone, and the incident reports are sent to a server for processing. In addition, the server continuously or intermittently geolocates each mobile device in the network and saves its location. Detection logic on the server analyzes the incident report, calculates an incubation period for the disease described in the incident report, backtracks the user's locations during the incubation period, identifies one or more infectious sites, and identifies other users who visited an infectious site and may be potentially affected by the infectious site. The system prompts identified potentially affected users to enter real-time health data which may then be used to revise the parameters of the infectious site and identify further potentially affected users. A constant feedback loop enables the system to “learn” about the disease and identify potentially affected users, whereupon health recommendations are provided to affected users (which may include not to leave home) thereby containing the spread of the disease.

The system may also warn users who are not affected, but may become affected in the future because they are likely to visit an infectious site. Based on an analysis of historical location data, the system is able to determine patterns in a user's routine and can determine ahead of time where a user is expected to be and when.

The system can also provide a massive amount of collected disease-related data to health authorities for further investigation and emergency response planning.

The system can also backtrack through the spread of infection to identify the location where the disease originated.

The system can also provide a user with advice and recommendations, direct the user to a nearby hospital, and order an ambulance to the user's current location.

The system can also be used to direct certain patients to certain hospitals, for example in order to evenly distribute the number of patients across area hospitals or to ensure that users with similar diseases in the same area treated in the same hospital.

The system can also warn users which the system identifies as relevant based on the particular circumstances, about non-infectious safety conditions as that information becomes available from other users who are affected. Examples of non-infectious safety conditions about which the system can identify relevant users to warn include nearby shark sightings or food poisoning detected at a restaurant.

According to the present invention there is provided a method for identifying an infectious site, the method including a server (a) receiving location updates for a first person, (b) storing the location updates in non-volatile memory, the stored location updates being a location log for the first person, (c) receiving a first health report for the first person, the first health report including a description of symptoms experienced by the first person, (d) calculating, based at least partly on the first health report, an incubation period for the first person, (e) determining, based at least partly on the location log for the first person, one or more locations visited by the first person during the incubation period, each visited location then being identified as an infectious site, (f) receiving and storing in non-volatile memory respective location updates for one or more other persons, the respective stored location updates being a respective location log for each of the one or more other persons; and (g) sending a notification to each of the one or more other persons who, based on the respective location log for each of the one or more other persons, visited an infectious site.

Preferably, the method includes the server (a) sending a notification to each one or more other persons who, based on the respective location log for each one or more other persons, is at risk of visiting a said infectious site, where each notification includes a request to submit a respective second health report, the second health report including at least respective symptoms for the one or more other persons, and the server receiving the second health report; (b) revising one or more parameters of the infectious site based on the second health report, where the parameters of an infectious site include a space boundary, a time boundary and a threat level associated with the infectious site, and upon revising one or more parameters of the infectious site, sending a notification to each of the one or more other persons who, based on the respective location log of the one or more other persons and the revised infectious site, are at risk of being or becoming infected with a disease associated with the infectious site; (c) estimating one or more disease parameters associated with a disease associated with an infectious site, wherein the one or more disease parameters are selected from the list consisting of a mode of transmission, a possibility of airborne infection, and a lifespan outside a host; (d) revising, based on data in the second health report, the one or more disease parameters associated with a disease estimated to be present at the infectious site; (e) receiving personal data for the first person, where the personal data includes one or more of the age of the first person, the race of the first person, the gender of the first person, the occupation of the first person, and the medical history of the first person, and where the calculation of the incubation period is also based partly on the personal data; (f) calculating a contagion period for the first person, and determining one or more other locations visited by the first person during the contagion period, each such location also being identified as an infectious site, and sending a notification to each one or more other persons who, based on each other person's respective location log, visited the one or more other locations subsequent to the first person.

According to the present invention there is further provided a method of detecting a disease outbreak, the method including a server (a) receiving respective location updates from each of a plurality of persons, the respective location updates including at least one respective location visited by each person; (b) storing the respective location updates in a non-volatile memory; (c) receiving respective health reports from each of the plurality of persons, the respective health report including at least a description of at least one respective symptom; and (d) establishing links between persons whose health reports include at least one symptom in common and whose location logs include at least one location in common, the existence of the links being suggestive of a disease outbreak in the at least one location.

According to the present invention there is further provided a method of detecting a global disease outbreak, the method including a server (a) receiving, on an ongoing basis, sequential location updates from a mobile device associated with a person infected with an infectious disease, each of the location updates including location coordinates indicative of a geographical territory wherein the mobile device is located at the time of the location update; (b) storing the location updates in a non-volatile memory, the stored location updates being a location log for the person; (c) for each received location update, comparing a geographical territory indicated by the location update with a geographical territory indicated by the immediately preceding location update; and (d) detecting when the received location update indicates a geographical territory which is different than the geographical territory which was indicated by the immediately preceding location update.

According to the present invention there is further provided a method of diagnosing a medical condition in a person, the method including a server (a) receiving and storing in a non-volatile memory, location updates for the person; (b) receiving a health report for the person, the health report including a description of at least one symptom experienced by the person; and (c) determining, based at least in part on the stored location updates and the health report, the medical condition.

According to the present invention there is further provided a method of detecting and warning of location-specific hazards, the method including a server (a) receiving and storing in a non-volatile memory respective location updates for each of a plurality of persons; (b) receiving from at least one of the persons a hazard report, the hazard report describing a hazard; (c) determining a location for the hazard based at least in part on the person's respective location at the time of receipt of the report; (d) determining, based at least in part on the stored location updates, which if any other of the plurality of persons are endangered by the hazard; and (e) sending a notification to each of the endangered persons warning of the hazard.

According to the present invention there is further provided a server, the server including (a) a processor; and (b) a non-volatile memory, operationally coupled to said processor, on which is stored executable code readable by said processor, the code including (i) geolocation logic configured to geolocate a mobile device and store geolocation data associated with the geolocated mobile device in a non-volatile memory; (ii) receiving logic configured to receive disease data from the mobile device, the disease data including at least symptoms of a disease associated with a user of the mobile device, (iii) detection logic for processing disease data received by the receiving logic, the detection logic being configured to detect one or more infectious sites associated with the disease data, and to identify one or more other mobile devices which have visited the infectious site based on the one or more other mobile devices' respective geolocation data, and (iv) notification logic for sending a notification to at least one of the one or more other mobile devices when the detection logic detects that the one or more other mobile devices visited a location which was detected by the detection logic to be an infectious site.

According to the present invention there is further provided a non-transient computer-readable storage medium having computer readable code embodied on the computer-readable storage medium, the computer readable code comprising a set of instructions that when executed on a mobile device causes the mobile device to: (a) receive health data from a user of the mobile device; (b) send the health data to a server configured to be in communication with the mobile device; (c) receive disease data from the server; and (d) display the disease data on the mobile device; wherein the health data is selected from the group consisting of symptoms and confirmed disease, and wherein the disease data is selected from the group consisting of a diagnosis of a medical condition, a notification of a detected disease in a location which was visited by the mobile device, and a notification of a detected disease in a location which the mobile device is at risk of visiting.

### BRIEF DESCRIPTION OF THE DRAWINGS

Various embodiments are herein described, by way of example only, with reference to the accompanying drawings, wherein:

FIGS. 1A-4C are screenshots illustrating one embodiment of a graphical user interface of a client application interacting with the system of the present invention;

FIGS. 5-7 are flow diagrams illustrating one embodiment of a method for detecting an infectious site according to the present invention;

FIG. 8 is a flow diagram illustrating one embodiment of a method for detecting and warning of location-based hazards according to the present invention;

FIG. 9 is a flow diagram illustrating one embodiment of a method for detecting a disease outbreak according to the present invention.

FIG. 10 is a flow diagram illustrating one embodiment of a method for detecting when a disease outbreak has become a global disease outbreak according to the present invention.

FIG. 11 is a flow diagram illustrating one embodiment of a method for diagnosing a medical condition according to the present invention.

FIG. 12 is a high level block diagram of a server and mobile device configured according to the present invention.

### DESCRIPTION OF THE PREFERRED EMBODIMENTS

The principles and operation of a method and system for detecting, identifying, and alerting of outbreaks in real-time according to the present invention may be better understood with reference to the drawings and the accompanying description.

In a preferred embodiment the system includes a server which receives and stores location updates from mobile devices in the network, each mobile device being associated with a user, i.e. a person. A “location update” is time-stamped location data indicating where the mobile device is geographically located. The data may be expressed in a known geographic coordinate system, such as longitude and latitude, or in any format recognizable by the system as a distinct location marker. Location updates are stored by the server in order provide a “location log”, which is a log of where a person has been when. In one embodiment location updates may be received by the server, for example by the server periodically geolocating each mobile device. In another embodiment, each mobile device may be programmed to periodically at pre-set intervals, or in response to location changes, transmit location updates to the server. Methods of geolocating mobile devices are well known in the art. For example, a mobile device may be geolocated using GPS satellites, or by technologies that triangulate the location based on proximity to the nearest cell phone transmission towers. The device's Internet IP address and/or connection to a wireless access point may also be used to geolocate a device, as well as any combination of one or more of the above methods or with other known methods.

As used herein “server” refers to a machine, such as a computer, and may include a collection of servers. “Mobile device” refers to any geolocation-enabled mobile computing device, such as a mobile phone, laptop, tablet, PDA, GPS unit, etc. The “network” consists of a server and one or more mobile devices which are in periodic, intermittent, or constant communication with the server using standard methods of mobile communications which are well known to persons skilled in the art.

At either pre-set intervals or in response to a specific triggering event, such as the receipt of an incident report, the system mines user location logs in order to establish a link between two or more users who have visited a common site, i.e. geographic location, within a specific period of time. As used herein, an “incident report” refers to data which is entered by a user into a mobile device which is then transmitted to the server. An incident report may fall into one of two categories: a health report or a hazard report. A “health report” is data containing either a description of a confirmed disease which the user has, or at least one illness symptom being experienced by the user. A “hazard report” is data describing a location-specific health hazard, e.g. chemical spill, snake, radon, etc. in the user's immediate vicinity. In a preferred embodiment a user submits an incident report via a Graphical User Interface (GUI) which is part of a client application loaded onto a user's mobile device for communicating with the server. An incident report received by the server is stored in non-volatile memory along with at least a description of the user, time, and device location associated with the report submission.

Once the server receives an incident report, potentially affected users are identified by the system. Depending on the type of incident report, potentially affected other users may be identified by the system using at least the location logs associated with those other users. The system may also use any health reports received from other users to help identify potentially affected other users. In one embodiment, if a first user submits a health report consisting of a confirmed disease, the system may calculate the probable incubation period for the disease in the first user, and may also calculate the probable infectious, i.e. contagious, period of the disease in the first user. The system may determine that potentially affected other users are those users whose location logs indicate that those users have been proximate to one or more locations which the first user had been to during the probable incubation and/or infectious period.

In another embodiment, the system may determine that potentially affected other users are those other users who, in addition to the above, also submitted a health report describing at least one symptom related to the disease.

In another embodiment, if a first user submits a health report consisting of one or more symptoms, the system may identify potentially affected users in the same manner as if the first user reported a confirmed disease, except that the system may look for users that reported at least one symptom in common with the first user. In another embodiment, the system may determine what constitutes a potentially affected user differently depending on whether the first user reported a confirmed disease or symptoms.

In another embodiment, if a first user submits a hazard report, the system may determine that potentially affected users are those users who are or who will be in the vicinity of the hazard. These users are also referred to herein as “endangered users”.

In one embodiment, potentially affected users may also include those users who are at risk of visiting, in the near future, a location determined by the system to be infectious or hazardous. The system may identify such at-risk users based on those users' predicted immediate travel path, which in turn may be based on the most recent several location updates. Alternatively, patterns of consistencies in a user's location log may be identified which may be indicative of a repeating routine (e.g. swimming lessons every other Tuesday at 4:00 pm), and may thus be used to predict a user's future location.

Once identified, the system may send notifications to potentially affected users' mobile devices. Notifications may include a visual component which is displayed on the GUI, and an audible component which may cause an audible alert to be sounded on the mobile device. The visual component of the notification may include, where appropriate, any one or more of a warning, a recommendation, and a prompt to enter additional data. For example, a notification sent to a potentially affected user may: warn the user that an infectious disease was detected at a location where the user had been, advise the user to see a doctor, and prompt the user to submit a health report identifying any current symptoms or answer specific relevant questions. A notification sent to a user with a confirmed infectious disease may advise the user to quarantine himself/herself until further notice. A notification sent to a user potentially affected by a hazard may advise the user to clear the area immediately, and/or report if the hazard is still there. In one embodiment, a first notification may be followed by one or more subsequent notifications which may contain the same or different content than the first notification. For example, a modified subsequent notification may remind the user to submit a health report if the user hadn't already done so. The system may be in communication with a disease database and/or learn about the disease from other infected users in order to provide appropriate recommendations. For example, a notification may include a question where the user is asked to submit data indicating which methods of treatment seem to work well. Once the data is sent to the system, the system may, in notifications sent to other users, recommend the method of treatment.

Infectious Site Detection

A method of detecting an infectious site will now be described. An “infectious site” is a location having specific boundaries, which, for a specific time frame, is believed to contain or be proximate to one or more pathogens which are likely to infect persons that attend at or near the location.

The system identifies infectious sites by initially: a) determining an illness being suffered by a user; b) if an infectious disease, calculating an incubation period for the disease in the user; c) backtracking through the user's location logs to determine where the user was at the time of infection, and c) identifying any such locations as infectious sites.

Subsequently, additional data received by the system may cause the system to confirm, reject, or refine the identification of an infectious site. The identification of an infectious site may be confirmed, for example, if the system receives subsequent health data from other users who had been to the infectious site and were also infected. Likewise, the identification of an infectious site may be rejected if a substantial number of users visited the site and were not affected, or as another example, if the system receives additional health data from the user which suggest certain estimates or calculations which were relied on to identify an infectious site should be rejected in favor of new estimates or calculations. The identification of an infectious site may be revised, for example, if subsequent health data received from any user suggest that the time period for infection associated with infectious site should be lengthened, shortened, or varied altogether, or the physical boundaries should be expanded or narrowed.

The system may also assign a threat level to each identified infectious site based on the estimated chances of the site infecting someone, which in turn may be based on the perceived infectiousness of particular pathogen or the number of days the site has already been infectious.

The system may determine the illness in the first step of the process, by receiving symptoms from the user and cross-referencing those symptoms with data in a disease database. Alternatively or in addition, the system may cross-reference the received symptoms with diseases that were reported by other users or identified by the system which are known to be present in the user's current or past locations. The user may also identify the illness for the system.

Calculating an Incubation Period and Contagious Period

A method of calculating an incubation period and contagious period will now be described. In one embodiment the system may estimate an initial incubation period and contagious period based on the probable disease as determined by the system based on one or more of the symptoms reported by the user, data retrieved from a disease reference database, and known or suspected diseases present in the user's current or past locations. In one embodiment, once a probable disease is determined, the system estimates the incubation and contagious period based on the disease, preferably with reference to a disease database. In another embodiment, the system may also use information learned by the system about the particular disease, for example using data reported by other users. In another embodiment, the system may also use personal data associated with the user to estimate the incubation period and contagious period. “Personal data” may include one or more of the user's age, race, gender, occupation, and medical history (for example, someone with a weakened immune system may experience a different incubation period and/or contagious period, depending on the particular disease. Personal data may be collected by the system at the time a user registers to use the system. In another embodiment, the system may also use other relevant data which the system can request from the user in order to calculate the incubation period and/or contagious period. For example, the system may request from the user the user's current body temperature or the date of the user's last contact with birds, or the date of the onset of the symptoms. The initial estimated incubation and/or contagious period may be further refined as more health data becomes available to the system. Statistical analysis such as Bayesian inferences can be used to refine the initial estimates based on the expected vs. actual outcomes. In situations where the disease is known, the system may retrieve from a disease database the actual incubation period according to the disease type and other factors such as the age of the user.

Once an incubation period for a disease in a user is known or estimated, the system may determine one or more infectious sites by backtracking through the location log associated with the user and identifying one or more locations where the user had been during the incubation period of the disease. The system may also cross-reference the user's past locations with the past locations of other users who may be experiencing similar symptoms in order to help identify an infectious site. As more and more real-time health data is received by the system, the system may identify infectious sites with greater precision. As new infectious sites are identified and existing infectious sites revised, for example by physical boundaries or time boundaries, potentially affected users may be notified. Each time the system notifies a potentially affected user, the notification may include a request, such as a prompt, to enter additional health data, which may then be used by the system to make further refinements or identify new sites.

Once a contagious period for a disease in a user is known or estimated, the system may identify an infectious site by tracking all locations visited by the user while contagious and identifying each such site as an infectious site.

Detecting Disease Outbreaks

The system may also detect a disease outbreak at an early stage, by identifying multiple users who are experiencing illnesses with similar symptoms. In one embodiment the system may detect an outbreak if a number of users report similar symptoms. In another embodiment the system may detect an outbreak by establishing a location link between users who report similar symptoms, for example if the user's locations can be traced back to common point of infection, which can be either a location or another infected person. Once an infected user is identified by the system, the system may also track the user's locations in order to track the spread of the disease. All such user tracking may be done anonymously to ensure the privacy of users. Furthermore, the system may detect when a disease which was previously contained within a single country or territory has become global, by monitoring the locations of infected users and detecting when a user crosses an international boundary. In one embodiment, the system may also warn authorities in the destination country that an infected user has entered the country. In one embodiment, the system may also provide a health authority in the destination country with the current location of the infected user.

Site and Disease Parameters

Preferably, the system should assign space and time boundaries, and a threat level to an infectious site. As used herein, “space boundaries” of an infectious site are the precise physical bounds of the infectious site as defined by actual location coordinates in any reference system, while “time boundaries” of an infectious site refers to the time period during which the site is considered to be infectious, and may be indicated as a series of calendar days which is bounded by a lower bound representing the start date and an upper bound representing the end date. Space and time boundaries may be assigned by the system to the infectious site based on the disease parameters of the particular disease. A “threat level” may be expressed as a constant or as a probability of infecting a person at varying distances from the infectious site. Threat levels may be assigned to a site based on the characteristics of the person who brought the infection to the site. For example, if the site became infectious with H1N1 from a 20-25 year old Caucasian female with average weight and height that suffering from H1N1, the site may be assigned a threat level of 50% at less than 5 m and 10% at more than 10 m up to 15 m, for a time period of 10 days. On the other hand, if the site became infected by a 20-30 year old male, the site may be infectious at 25%-90% at 0-25 m for a period of 15 days.

Disease parameters also affect the space and time boundaries and threat level. As used herein “disease parameters” are any characteristics of the pathogen or environmental factors that would affect the likelihood of a transmission of the pathogen from one person to another. Examples of disease parameters would include such things as mode of transmission, e.g. direct vs. indirect contact, whether airborne infection is possible, the lifespan of the pathogen outside a host, or any other relevant information. If the disease is known, the disease parameters may be obtained from a disease database. If the disease is unknown, initial disease parameters may be estimated and later refined once more real-time health data becomes available. Using known or estimated disease parameters, the system may assign initial space and time boundaries to the infectious site, and identify and notify potentially affected users. These users in turn may then provide additional real-time health data, leading to further refinement, identification, notification, further refinement, etc. Statistical analysis, such as Bayesian inferences, can be used to estimate the disease parameters based on the data being reported by affected users.

Disease Identification

In cases of unknown or unconfirmed diseases, the system may also be able to identify the disease. As part of the notification sent to affected users, the system can also prompt affected users with very specific questions designed to help identify the disease. For example, an affected user may be asked by the system “have you been in contact with a bird lately?” The questions may be determined by a human being monitoring the system, or a sophisticated computer program responding to real-time data entering the system. The system may also learn the identity of the disease from users. In one embodiment, if users reports symptoms of an unknown disease, the system may, as part of the notification, ask those users to see a doctor and submit a follow up health report if a disease is confirmed. The system may also display reminders on a user's device to visit a doctor, or automatically set reminders on a mobile device's calendar application.

Identifying Disease Parameters for New Outbreaks

The system may also be able to identify disease parameters for new disease outbreaks based on the accumulated health data received from users. In one embodiment the system may send disease data to other organizations such as an investigative body, a disease detection and prevention authority, or a health treatment facility. In one embodiment the system may be able to detect deaths associated with the disease. For example, the system may receive from a mobile device a location update indicating the mobile phone (and thus user) is in a hospital. The system may continue to receive location updates from the same location until the location updates suddenly stop. The server may flag this event as suggestive that the user may have died.

Other System Functions

The system can also be used to identify the source of the disease by backtracking through reported incidents of infections (or symptoms) until the first infected user is identified. The system can also intelligently direct affected users to area hospitals. For example, one of the contributing factors to the spread of outbreaks is the inability of health practitioners treating a small number of infected patients, to recognize early enough on that in fact an outbreak may be in progress. Thus an early patient falling victim to a disease outbreak may not be treated appropriately. For example, the patient may not be quarantined, leading to further incidents of infection which could have been contained had the outbreak been detected earlier. The system may therefore direct local users to the same hospital by including in the notification a specific hospital the user should visit.

Location Based Hazards

The system can also be used to identify and notify affected users of other safety related location-based hazards, for example nearby shark sightings being reported by other users. In another embodiment, the system may detect location-based hazards. For example, the system may receive incident reports from one or more users reporting feeling ill. The system determines that there is not an immediate threat of an infectious disease, but the one or more users recently visited a particular restaurant, and the symptoms are consistent with food-poisoning. The system can identify the illness as probably food poisoning, and identify and notify other users who visited the restaurant, are likely to visit the restaurant, or are just in the vicinity of the restaurant.

Client-Side User Application

Preferably, the system interacts with a user through a client-side user application. In one embodiment the user downloads the client application and installs the application on the user's computer and/or mobile device. In another embodiment the application runs in a web browser on the user's computer. Preferably, the client application handles receiving input from a user and displaying notifications to a user. In one embodiment, the client application may also provide users with a host of other valuable information and services. For example, the system may advise the user of the nearest hospital and expected ETA to the hospital, provide a map and directions to the hospital, or an option to phone the hospital directly from the system GUI. The system may also provide the ability for a user to input and store personal medical information which the system can automatically send to the hospital admitting department. The system may also automatically order an ambulance to be dispatched to the user's current location.

The system may also provide users the ability to set alert thresholds according to their personal preferences. For example, a user may choose to receive all alerts, local area alerts, alerts only affecting the user, high-risk alerts, or no alerts at all.

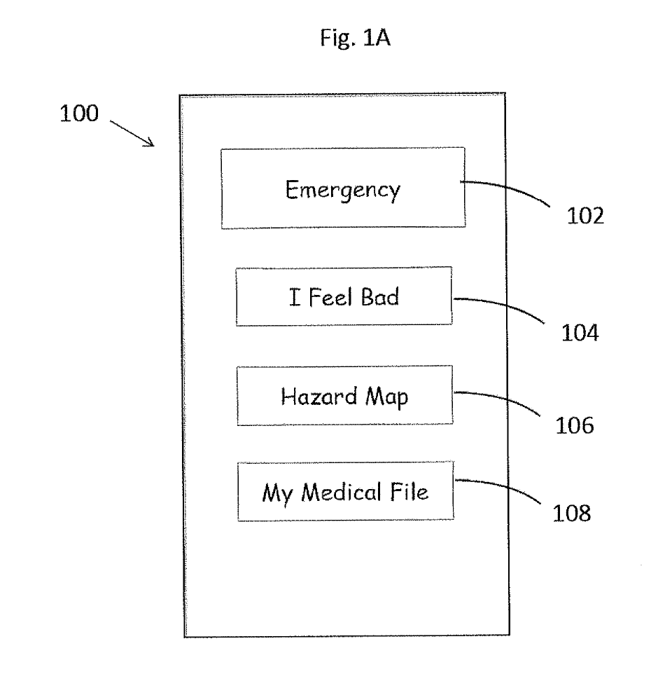

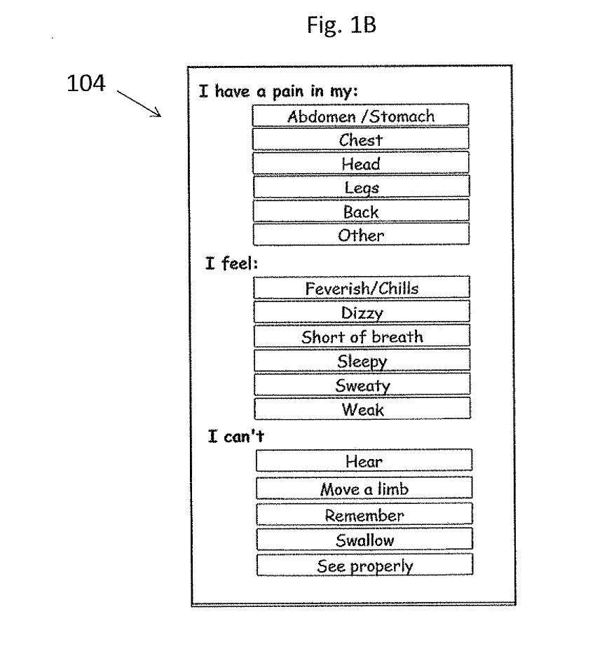

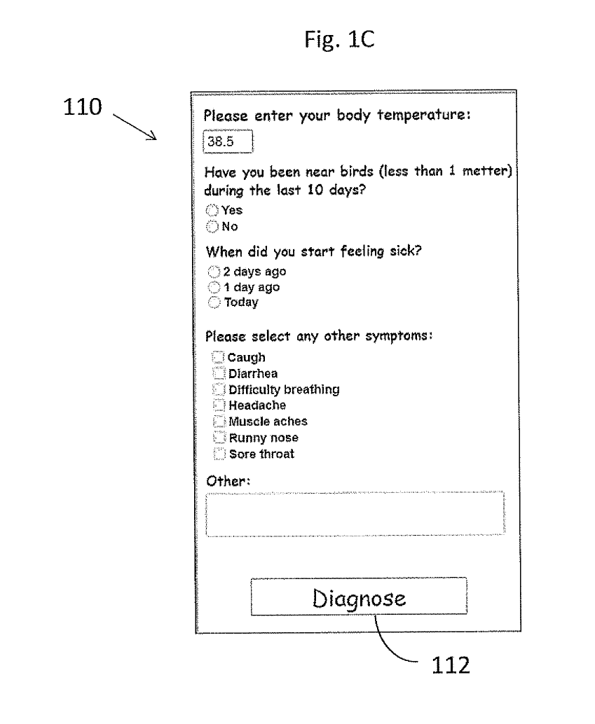

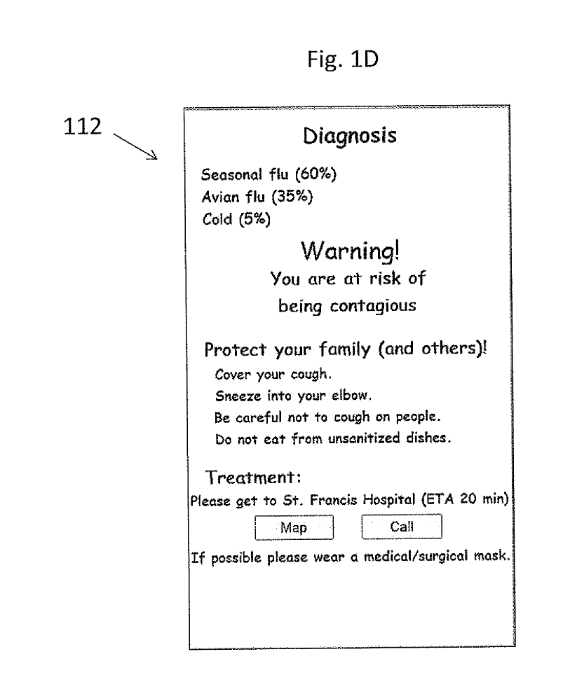

Referring now to the drawings, FIGS. 1A-4C illustrate sample screenshots of a Graphical User Interface (GUI) in which a user can interact with the system. FIG. 1A shows an initial screen where the user is presented with a top level menu 100 in which the user may choose various functions such as get help for an emergency 102, report symptoms of feeling ill 104, view a map or list of nearby hazards 106, or view the user's medical file 108.

FIG. 1B shows a sub-menu for reporting symptoms of feeling ill 104, where the user can choose one or more symptoms from the list shown.

FIG. 1C shows a subsequent reporting screen 110 where the user may be asked to enter a variety of related information such as current body temperature, whether the user was near birds, how many days ago the symptoms appeared, and whether there are any other symptoms being experienced. The user may submit the information entered on reporting screen 110 by clicking or tapping on a button 112.

FIG. 1D shows a sample diagnosis screen which may be displayed upon the user clicking or tapping 112. There may be displayed to the user a list of likely diseases which the user is infected with along with a percentage representing a computed probability of the indicated disease being the disease the user is infected with. There may also be displayed to the user health related advice and suggested treatment, which may include getting to a hospital. There may also be calculated and displayed the closest hospital with expected time of arrival. There may also be displayed to the user options to display a map or call the hospital.

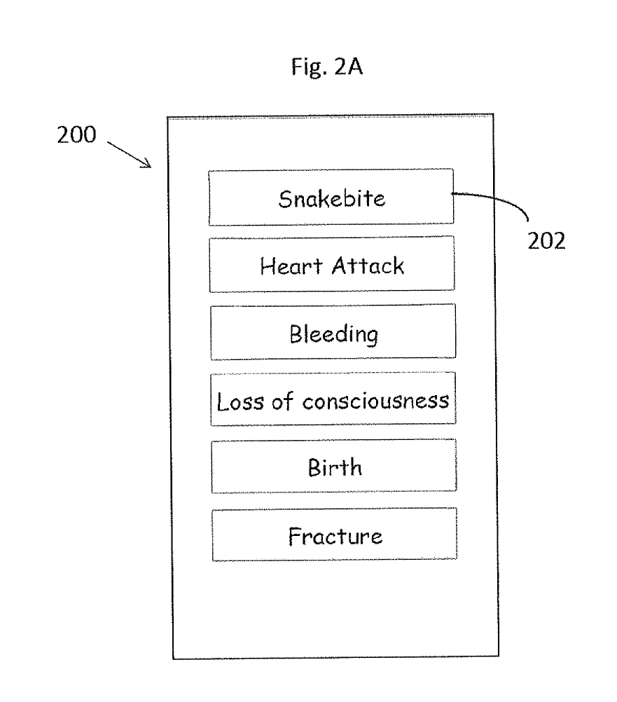

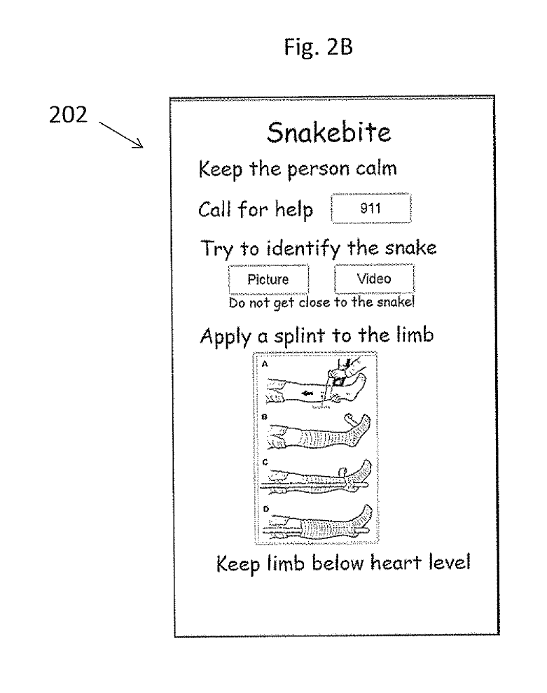

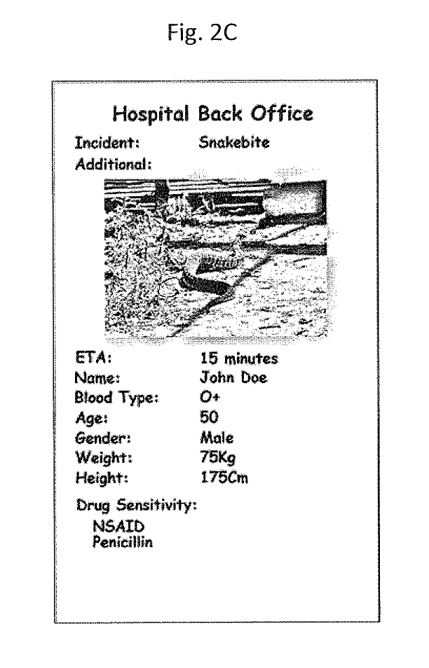

FIG. 2A is a sample sub-menu of 102. The user is presented with a choice of medical emergencies for which advice can be sought, for example snake bite 202.

FIG. 2B is a screen that may be presented to a user who clicks or taps on 202. There may be displayed to the user first-aid advice, a picture diagram for applying a splint, options to dial an emergency telephone number, or take a photo or video of the snake. A record of the incident including photo and/or video may be automatically sent to the nearest hospital or other treatment facility along with a user's personal medical profile.

FIG. 2C shows an example screen on which is displayed information relevant to the emergency incident reported in 202 along with the user's personal medical profile. A user's personal medical profile may be entered and viewed by the user by accessing his/her medical file 108 from top level menu 100. The information shown in FIG. 2C may be displayed for the user and/or automatically sent to a computer or mobile device at an emergency treatment facility in the user's vicinity or which the system may calculate as the being the closest by distance or time. The system may also compute an expected time of arrival at the treatment facility.

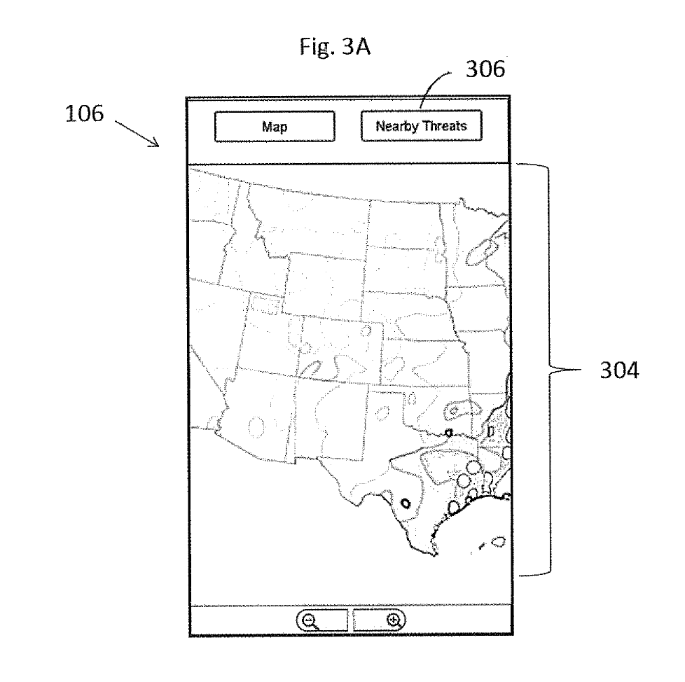

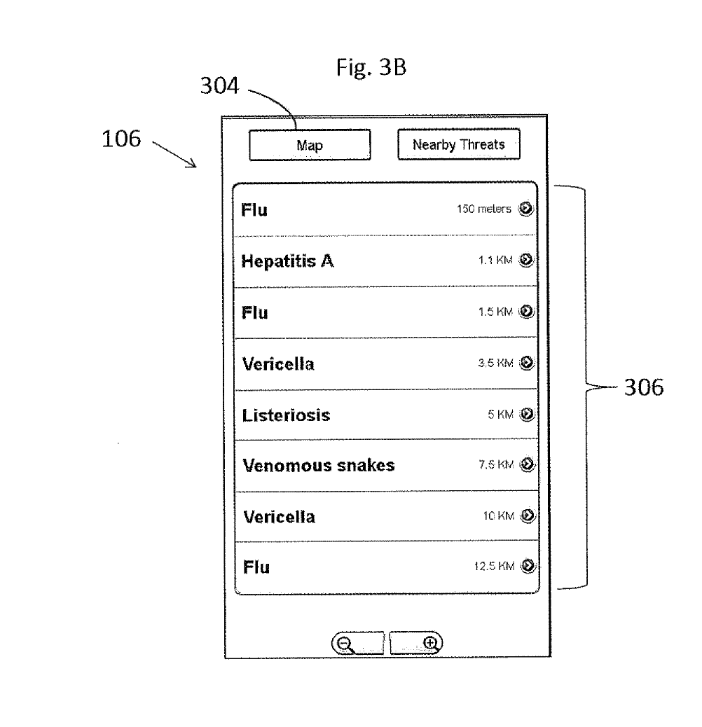

FIGS. 3A-3B are screens which may be displayed to a user after a user selects hazard map 106 from top level menu 100. Hazard map 106 may initially display a map view 304 of area hazards, and allow a user to toggle between map view 304 and list view 306. Map view 304 may display a list of detected hazards and distance to each hazard from the user's present location. Map view 304 may display a geographical map of the user's vicinity or larger geographical territory, region, or continent with areas of detected disease outbreaks indicated by colors or shading which may represent for example disease type or number of incidents detected, but any other relevant information may be represented as well. List view 306 may display a list of detected hazards and distance to each hazard from the user's present location, and may also allow a user to access additional relevant information pertaining to each hazard shown in the list, such as range, number of incidents detected, general disease information, or tips to avoid infection.

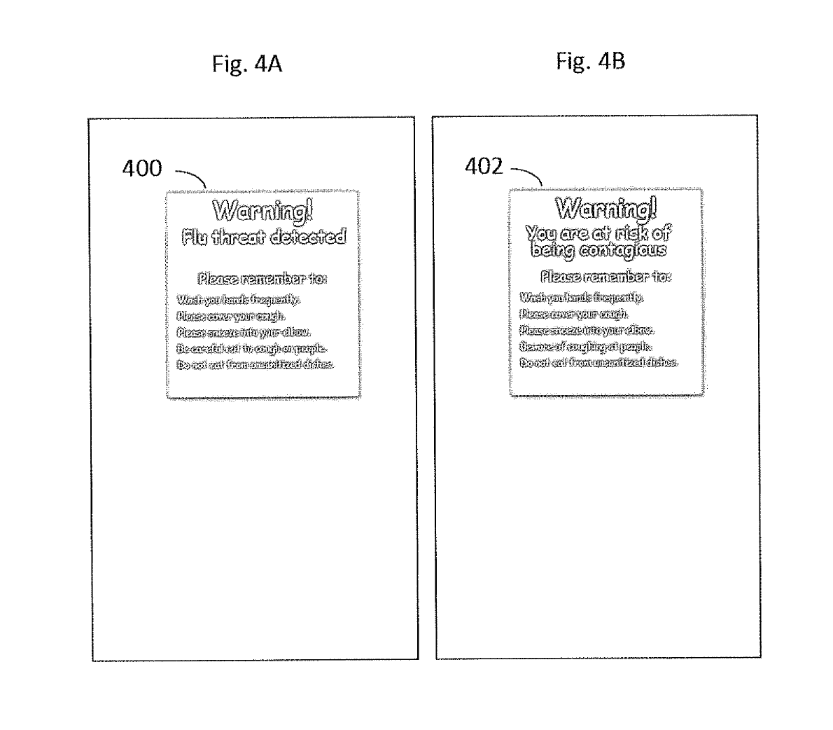

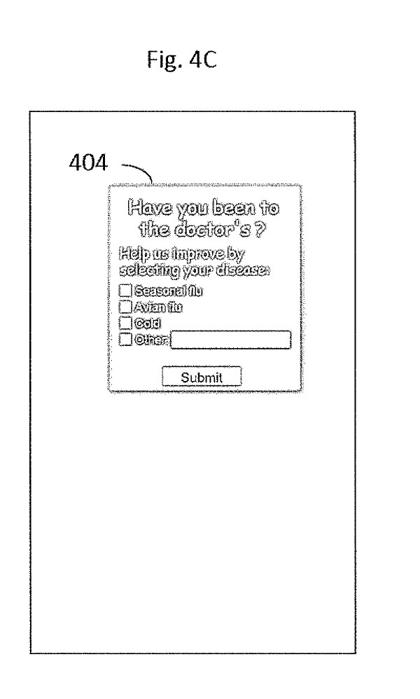

FIGS. 4A-4C illustrates sample notifications 400, 402 and 404 which may sent by the system to a user's mobile device and may be automatically displayed on the user's mobile device upon a certain event be detected by the system. For example, sample notification 400 in FIG. 4A includes an alert that may be generated and sent to a mobile device when the system detects that the mobile device (and hence the user) is likely to enter or just entered an infectious area. Sample notification 400 may identify the specific hazard or threat detected, and may offer health advice. In FIG. 4B, sample notification 402 may be generated by the system and sent to a user's mobile device when the user has been identified by the system as being infected by a disease and has high likelihood of being contagious. For example, based on the user's location log and data obtained from other users the system may have determined that the mobile device (and hence user) had at some point in the past entered an area likely to be infected with flu and the user is likely to be infected with flu. In FIG. 4C sample notification 404 includes a request to submit additional information. A user may be presented with sample notification 404 if, for example, the user previously reported symptoms of feeling ill and the system advised the user to see a doctor. Using additional information which the user may enter in response to sample notification 404, the system may determine the identity of a disease located at one or more infectious sites, revise the parameters of the infectious site accordingly, and detect and notify affected users as appropriate.

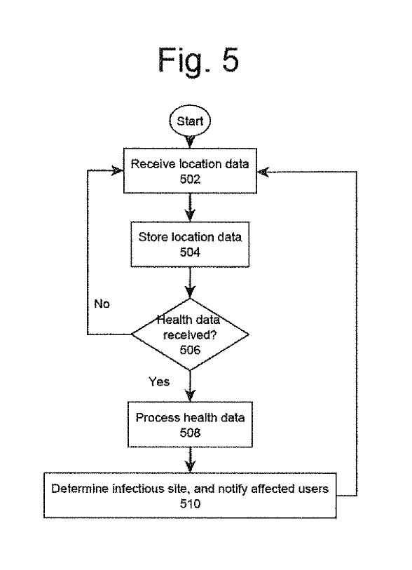

FIG. 5 is a flow diagram illustrating a method for identifying an infectious site. Location data is periodically received 502 from a mobile device and anonymously stored 504 in a non-volatile memory. If health data is received 505 from the mobile device, the health data is processed 508, which may including storing the health data in non-volatile memory. After processing the health data step 510 determines infectious sites and notifies affected users, whereupon the process repeats.

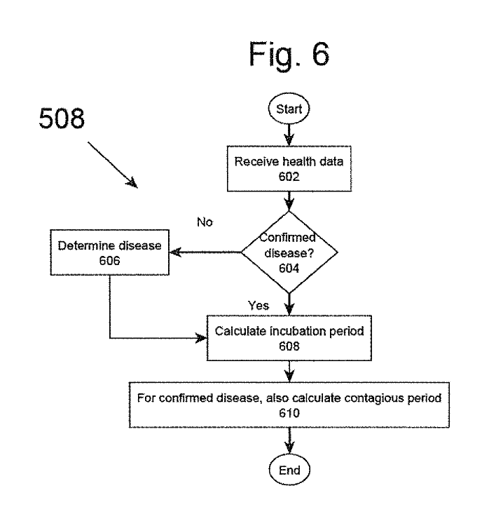

FIG. 6 illustrates how health data may be processed in 508. Received health data 602 may contain symptoms or a confirmed disease. If the health data does not include a confirmed disease 604, the disease is determined 606, which may be by estimating the disease using one of the methods described herein. Once the disease is determined, an incubation period is calculated 608. If the health data includes a confirmed disease, a contagious period may also be calculated 610.

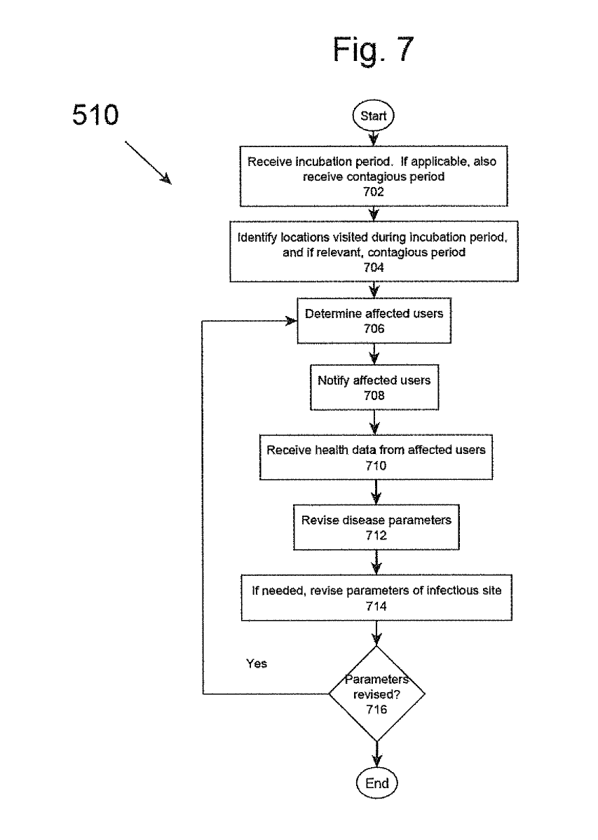

FIG. 7 illustrates how an infectious site may be determined and affected users notified in step 510. In step 702 an incubation period, and if applicable a contagious period is received from step 508 in FIG. 5. Using stored location data 504 for the user who reported being ill, the user's locations during the incubation period of the disease are determined 704, and these locations are identified as infectious sites with time, space, and threat level parameters determined based on known or estimated disease parameters. If applicable, the user's locations during the contagious period are also identified as infectious sites. Using stored location data 504 from other users, other potentially affected other users who have visited the infectious site(s) just identified are determined 706 and notified 708. The notification may request potentially affected users to enter relevant health data such as any current symptoms or confirmed diseases, in which case the relevant health data is received from the potentially affected users in step 710. If necessary in light of the additional health data, the disease parameters may be revised 712 which in turn may require revising parameters of the infectious site 714. If the infectious site parameters are revised, additional potentially affected users may be determined and the process repeated 716.

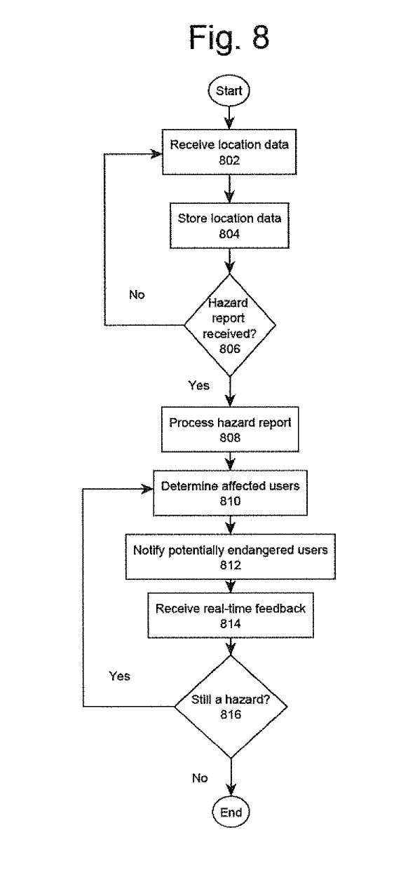

FIG. 8 illustrates a method of detecting and warning of location-specific hazards. User location data is received 802 from a mobile device and stored 804 in non-volatile memory. If a location-stamped hazard report is received 806, the hazard report is processed 808, which may include storing the hazard report in non-volatile memory. Potentially endangered users are determined 810 by reviewing the stored location data of other users to detect if any other users are nearby or will soon be nearby. Depending on the specific hazard, potentially endangered users may also include users who were already at the site of the hazard in which case these users are determined. In step 812 endangered users are notified. The notification may include a request for real-time feedback to confirm, amongst other things, if the hazard is still applicable 814 in which case the method may enter a continuous loop of determining and notifying endangered users until the hazard no longer exists.

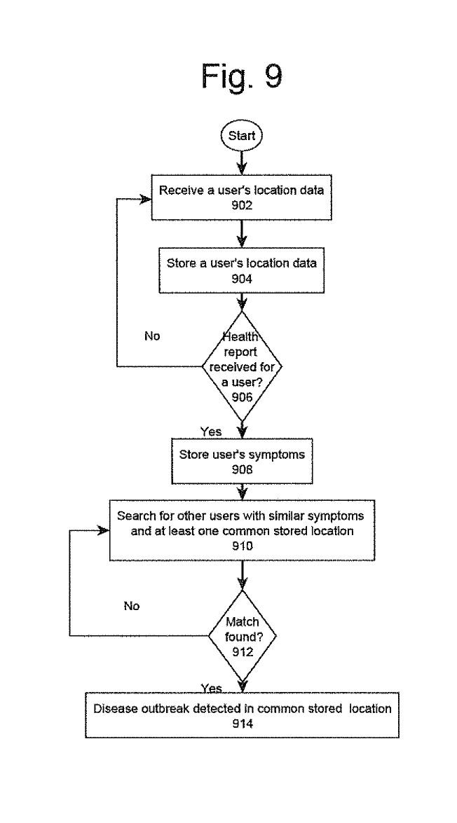

FIG. 9 illustrates a method for detecting a disease outbreak. A user's location data is periodically received 902 by a server and stored 904 in non-volatile memory. If the server receives a health report 906 which consists of symptoms, the user's symptoms are also stored 908 in non-volatile memory. The server searches for other system users who reported similar systems and who visited at least one location in common 910, and establishes links between these users in step 912. If links between users who reported similar systems are established, such links may be indicative of a disease outbreak in the at least one location in common 914.

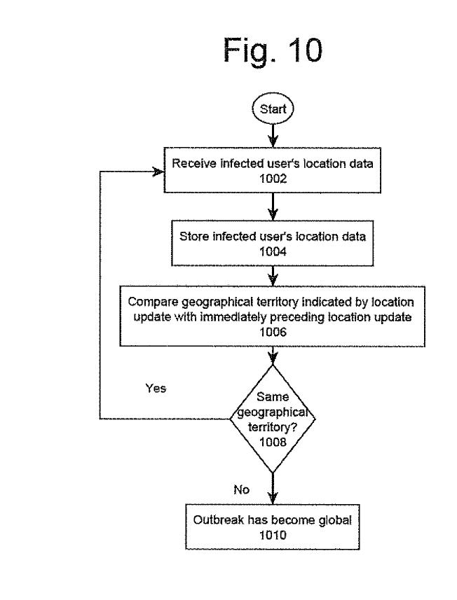

FIG. 10 illustrates a method for detecting when a disease outbreak becomes global, that is, the disease spreads from one geographical territory, such as a country, to another. An infected user's location data is periodically received 1002 by a server and stored 1004 in non-volatile memory. Each location update contains location coordinates which can be used to determine a geographical territory, such as country, in which the mobile device is located at the time of the location update. For each received location update, the geographical territory indicated by the location update is compared to the geographical territory indicated by the immediately preceding location update 1006. If the geographical territory indicated is not the same as the one indicated by the preceding location update 1008, the disease outbreak has crossed territorial boundaries and has become global 1010.

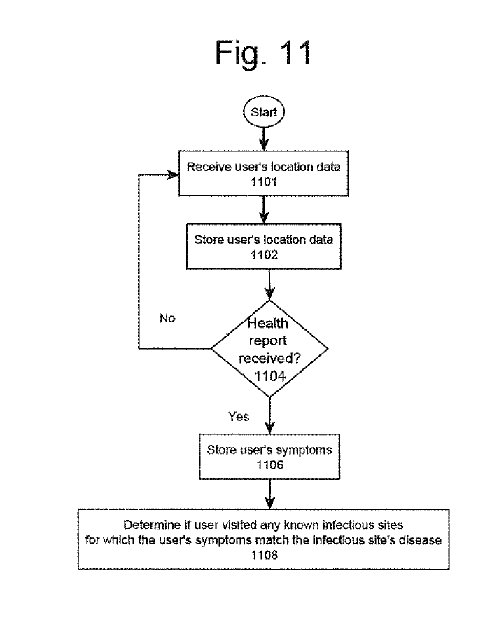

FIG. 11 illustrates a method for diagnosing a medical condition. A user's location data is periodically received 1101 by a server and stored 1102 in non-volatile memory. If the server receives a health report 1104 which consists of symptoms, the user's symptoms are stored 1106 in non-volatile memory. The server, using a database of known infectious sites, determines whether the user visited an infectious site containing a disease which is consistent with the symptoms being reported by the user, in which case the user's medical condition is diagnosed as the disease located at the infectious site 1108.

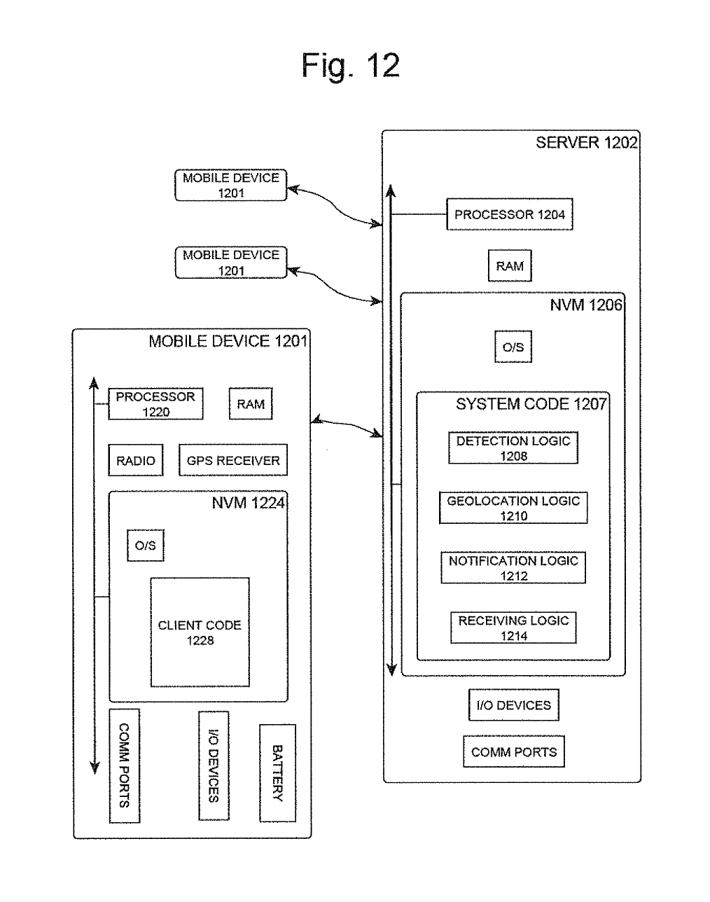

FIG. 12 illustrates a server 1202 configured to detect infectious sites according to the present invention, and a mobile device 1201 on which is installed a client application configured to communicate with server 1202. Server 1202 includes a processor 1204 which is operationally coupled to a non-volatile memory (NVM) 1206 such as a hard drive or flash memory, on which is stored computer executable system code 1207 readable by processor 1204. System code 1207 includes geolocation logic 1210, receiving logic 1214, detection logic 1208 and notification logic 1212. Geolocation logic 1210 includes code for causing the processor 1204 to geolocate a mobile device 1201 and store the mobile device's location in NVM 1206. Receiving logic 1214 includes code for causing the processor 1204 to receive disease data from a mobile device 1201, including at least disease symptoms, and to store the disease data in NVM 1206. Detection logic 1208 includes code for causing the processor 1204 to process the disease data and to detect one or more infectious sites associated with the disease data that may have caused the disease symptoms, and to identify one or more other mobile devices 1201 that have visited the infectious site based on those other mobile devices' stored locations as received and stored by geolocation logic 1210. Notification logic 1212 includes code for causing the processor 1204 to send notifications to one or more mobile devices 1201 as appropriate, for example notification logic 1212 may send a notification to mobile device 1201 if detection logic 1208 detects that mobile device 1201 visited an infectious site.

Mobile device 1201 includes a processor 1220 operationally coupled to non-volatile memory (NVM) 1224, on which is stored computer executable client code 1228 that when executed, causes processor 1220 to receive data from a user, send user data and location data to server 1202, receive notifications and hazard data from server 1202, and display notifications and hazard data on mobile device 1201. “Hazard data” includes disease data. In a preferred embodiment, client code 1228 includes a graphical user interface (GUI) for interacting with a user of mobile device 1201, including displaying notifications received from server 1202.

Server 1202 and mobile device 1201 may communicate using client-server communication protocols well known to persons skilled in the art. In addition, persons skilled in the art may design and build system code 1207 and client code 1228 using any programming language known in the art. Persons skilled in the art can easily design and building system code 1207 and client code 1228 to perform the methods and features described herein. In addition, while FIG. 12 provides an example of a software embodiment of the present invention, the illustrated logic blocks could be implemented as software, firmware, hardware or any combination thereof.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method for identifying at least one infectious site, comprising, by a server:
receiving one or more location updates for a first person;
storing said location updates in a non-volatile memory, said stored location updates being a location log for said first person;
receiving a first health report for said first person, said first health report including a description of at least one symptom experienced by said first person;
calculating, based at least in part on said first health report, an incubation period for said first person; and
determining, based at least in part on said location log for said first person, one or more locations visited by said first person during said incubation period, each said location then being identified as an infectious site.

2. The method of claim 1 further comprising, by the server:
receiving and storing in said non-volatile memory one or more respective location updates for one or more other persons, said respective stored location updates for each one or more other persons being a respective location log for each said other person; and
sending a notification to each said other person who, based on said respective location log for each said other person, visited a said infectious site.

3. The method of claim 2 further comprising, by the server:
sending a notification to each said one or more other persons who, based on said respective location log for each said other person, is at risk of visiting a said infectious site.

4. The method of claim 2 wherein each said notification includes a request to submit a respective second health report, said second health report including at least respective symptoms for said each other person.

5. The method of claim 4 further comprising, by the server:
receiving said second health report; and
revising one or more parameters of said infectious site based on said second health report, said parameters including a space boundary, a time boundary and a threat level associated with said infectious site.

6. The method of claim 5 further comprising, by the server:
upon revising said one or more parameters of said infectious site, sending a notification to each said one or more other persons who, based on said each other persons' respective location log and said revised infectious site parameters, are at risk of being or becoming infected with a disease associated with infectious site.

7. The method of claim 1 further comprising, by the server:
estimating one or more disease parameters associated with a disease associated with an infectious site, wherein said one or more disease parameters are selected from the list consisting of a mode of transmission, a possibility of airborne infection, and a lifespan outside a host.

8. The method of claim 7 further comprising, by the server:
receiving and storing in said non-volatile memory one or more respective location updates for one or more other persons, said respective stored location updates for each one or more other persons being a respective location log for each said other person;
sending a notification to each said other person who, based on said respective location log for each said other person, visited a said infectious site, wherein each said notification includes a request to submit a respective second health report, said second health report including at least respective symptoms for said each other person;
receiving said second health report; and
based on data in said second health report, revising said one or more disease parameters associated with a disease estimated to be present at said infectious site.

9. The method of claim 1 further comprising, by the server:
receiving personal data for said first person, said personal data including one or more of an age of said first person, a race of said first person, a gender of said first person, an occupation of said first person, and a medical history of said first person;
wherein said calculation of said incubation period is based at least in part on said personal data.

10. The method of claim 2 further comprising, by the server:
calculating a contagion period for said first person; and
determining one or more other locations visited by said first person during said contagion period, each of said other locations thus also being identified as an infectious site.

11. The method of claim 10 further comprising, by the server:
sending a notification to each said one or more other persons who, based on said each other person's respective location log, visited said one or more other locations subsequent to said first person.

12. A method of detecting a disease outbreak comprising, by a server:
receiving respective health reports from each of a plurality of persons, said respective health report including at least a description of at least one respective symptom; and
detecting when two or more of said received health reports include at least one symptom in common.

13. The method of claim 12 further comprising, by the server:
receiving respective location updates from each of said plurality of persons, said respective location updates including at least one respective location visited by said each person;
storing said respective location updates in a non-volatile memory;
establishing links between persons whose health reports include at least one symptom in common and whose location logs include at least one location in common, the existence of said links being suggestive of a disease outbreak in said at least one location.

14. A method of detecting a global disease outbreak, comprising, by a server:
receiving, on a periodic basis, sequential location updates from a mobile device associated with a person infected with an infectious disease, each of said location updates including location coordinates indicative of a geographical territory wherein said mobile device is located at the time of said location update;
storing said location updates in a non-volatile memory, said stored location updates being a location log for said person;
for each said received location update, comparing a geographical territory indicated by said location update with a geographical territory indicated by an immediately preceding location update; and
detecting when said received location update indicates a geographical territory which is different than a geographical territory which was indicated by an immediately preceding location update.

15. A method of diagnosing a medical condition in a person, comprising, by a server:
receiving, and storing in a non-volatile memory, location updates for the person;
receiving a health report for the person, said health report including a description of at least one symptom experienced by the person; and
determining, based at least in part on said stored location updates and said health report, the medical condition.

16. A method of detecting and warning of location-specific hazards, comprising, by a server:
receiving, and storing in a non-volatile memory, respective location updates for each of a plurality of persons;
receiving from at least one of said persons a hazard report, said hazard report describing a hazard;
determining a location for said hazard based at least in part on said at least one person's respective location at the time of receipt of said report;
determining, based at least in part on said stored location updates, which if any of said plurality of persons are endangered by said hazard; and
sending a notification to each of said endangered persons warning of said hazard.

17. A server comprising:
a processor; and
a non-volatile memory, operationally coupled to said processor, on which is stored executable code readable by said processor, said code including
geolocation logic configured to geolocate a mobile device and store geolocation data associated with said geolocated mobile device in a non-volatile memory;
receiving logic configured to receive disease data from said mobile device, said disease data including at least symptoms of a disease associated with a user of said mobile device,
detection logic for processing disease data received by said receiving logic, said detection logic being configured to detect one or more infectious sites associated with said disease data, and to identify one or more other mobile devices which have visited said infectious site based on said one or more other mobile devices' respective geolocation data, and
notification logic for sending a notification to at least one of said one or more other mobile devices when said detection logic detects that said at least one of said one or more other mobile devices visited a location which was detected by said detection logic to be an infectious site.

18. A non-transient computer-readable storage medium having computer readable code embodied on the computer-readable storage medium, the computer readable code comprising a set of instructions that when executed on a mobile device causes the mobile device to;
receive health data from a user of the mobile device;
send said health data to a server configured to be in communication with the mobile device;
receive disease data from said server; and
display said disease data on the mobile device;
wherein said health data is selected from the group consisting of symptoms and confirmed disease, and
wherein said disease data is selected from the group consisting of a diagnosis of a medical condition, a notification of a detected disease in a location which was visited by the mobile device, and a notification of a detected disease in a location which the mobile device is at risk of visiting.
